(19) United States
(12) Patent Application Publication
(10) Pub. No.: US 2025/0144971 A1
(43) Pub. Date: May 8, 2025

(54) APPARATUS AND METHOD FOR EXAMINING AN AIR CONDITIONER FOR A VEHICLE

(71) Applicants: HYUNDAI MOTOR COMPANY, Seoul (KR); KIA CORPORATION, Seoul (KR)

(72) Inventors: Jun Yeon Park, Hwaseong-si (KR); BeomKyo Lee, Hwaseong-si (KR); Hocheol Ahn, Hwaseong-si (KR); DooChul Kim, Hwaseong-si (KR); Sungjun Im, Hwaseong-si (KR)

(73) Assignees: HYUNDAI MOTOR COMPANY, Seoul (KR); KIA CORPORATION, Seoul (KR)

(21) Appl. No.: 18/904,836

(22) Filed: Oct. 2, 2024

(30) Foreign Application Priority Data
Nov. 3, 2023 (KR) 10-2023-0150980

(51) Int. Cl. B60H 1/00

(52) U.S. Cl. CPC B60H 1/00585

(57) ABSTRACT

An apparatus and method for examining an air conditioner for a vehicle are provided. The apparatus may include: an outside air temperature value receiving module configured to receive a vehicle outside air temperature value from an outside air temperature sensor; a refrigerant pressure value receiving module configured to receive a vehicle refrigerant pressure value from a refrigerant pressure sensor; a refrigerant amount examination module configured to examine a minimum amount of refrigerant in a vehicle by using the outside air temperature value and the refrigerant pressure value; and a notification display module configured to display a notification to a user according to a result of examining the amount of refrigerant.

### CROSS-REFERENCE TO RELATED APPLICATION

This application claims priority to and the benefit of Korean Patent Application No. 10-2023-0150980 filed in the Korean Intellectual Property Office on Nov. 3, 2023, the entire contents of which are incorporated herein by reference.

### BACKGROUND

### Technical Field

The disclosure relates to an apparatus and method for examining an air conditioner for a vehicle.

### Description of Related Art

During a process of manufacturing a vehicle, a cooling performance inspection is generally performed on the basis of deviations related to a change in degree of vacuum and a change in refrigerant pressure value. For example, during a vehicle facility process, a vacuum is formed in the vehicle by a vacuum pump before a refrigerant is injected. Then, in a state in which the vacuum pump does not operate, the amount of change in degree of vacuum may be measured, and a defect may be determined on the basis of the amount of change in degree of vacuum for a particular time. Alternatively, during a process of inspecting the vehicle, whether the refrigerant is defective may be determined depending on a determination criterion discovered through the inspections performed several times on the basis of a refrigerant pressure.

However, the above-mentioned method does not have high inspection reliability because of deviations caused by various variables, constraints on inspection time, and the like during the manufacturing process. For example, during the vehicle facility process, a deviation of the degree of vacuum may occur because of a temporal constraint on a working process, changes in temperature and humidity during the working process, and air conditioner piping routes that vary depending on the types of vehicles. During the process of inspecting the vehicle, a deviation of a refrigerant pressure value may occur because of the amount of remaining or injected refrigerant, whether an engine is turned on or off, a temperature in an engine compartment, temperature and humidity during the working process, and the like. In particular, because the pressure and temperature of the refrigerant vary depending on the conditions of an external environment, it is difficult to consistently compare the refrigerant pressure with a reference pressure corresponding to the temperature.

### SUMMARY

The present disclosure attempts to provide an apparatus and method for examining an air conditioner for a vehicle, which can detect a defect at an early stage by setting a minimum refrigerant pressure, which may be applied in common to various variables. The apparatus and method can also generate an in-vehicle inspection code when a refrigerant pressure is equal to or less than a set reference value in order to improve inspection reliability related to examination of an air conditioner for a vehicle.

The present disclosure also attempts to provide an apparatus and method for examining an air conditioner for a vehicle, which can determine a lack of refrigerant on the basis of a change in a temperature of an evaporator core temperature sensor by forcibly operating an air conditioner during a process of inspecting a vehicle.

An apparatus for examining an air conditioner for a vehicle according to an embodiment may include: an outside air temperature value receiving module configured to receive a vehicle outside air temperature value from an outside air temperature sensor; a refrigerant pressure value receiving module configured to receive a vehicle refrigerant pressure value from a refrigerant pressure sensor; a refrigerant amount examination module configured to examine the minimum amount of refrigerant in a vehicle by using the outside air temperature value and the refrigerant pressure value; and a notification display module configured to display a notification to a user according to a result of examining the amount of refrigerant.

In some embodiments, the refrigerant amount examination module may examine the minimum amount of refrigerant by using the refrigerant pressure value when the outside air temperature value is equal to or more than a predetermined first reference value.

In some embodiments, when the outside air temperature value is less than the first reference value, the refrigerant amount examination module may not perform the minimum amount of refrigerant examination. The notification display module may display, to the user, a notification indicating that the amount of refrigerant cannot be examined.

In some embodiments, when the refrigerant pressure is continuously maintained to be a predetermined second reference value or less for a predetermined time, the refrigerant amount examination module may determine that the amount of refrigerant is abnormal. The notification display module may display a refrigerant amount inspection request notification to the user.

In some embodiments, when the refrigerant pressure is not continuously maintained to be the second reference value or less for the predetermined time, the refrigerant amount examination module may determine that the amount of refrigerant is normal. The notification display module may display a normal refrigerant amount notification to the user.

In some embodiments, when it is determined that the outside air temperature sensor or the refrigerant pressure sensor is abnormal, the refrigerant amount examination module may not examine the amount of refrigerant. The notification display module may display an outside air temperature sensor inspection request notification or a refrigerant pressure sensor inspection request notification to the user.

In some embodiments, the refrigerant amount examination module may examine the minimum amount of refrigerant while the vehicle travels. The notification display module may display the notification while the vehicle travels.

In some embodiments, the apparatus for examining an air conditioner for a vehicle may further include a defect reason deduction module configured to deduce a defect reason on the basis of refrigerant injection history data in a factory when it is determined that the amount of refrigerant is abnormal.

An apparatus for examining an air conditioner for a vehicle according to another embodiment may include: an evaporator core temperature value receiving module configured to receive an evaporator core temperature value from an evaporator core temperature sensor of a vehicle; an air conditioner forced operation module configured to forcibly operate an air conditioner of the vehicle for a predetermined time; an air conditioner performance examination module configured to examine air conditioner performance of the vehicle by using the evaporator core temperature value according to the forced operation; and a notification display module configured to display a notification to a user according to a result of examining the air conditioner performance.

In some embodiments, when a first condition for determining whether the evaporator core temperature value reaches a predetermined third reference value for a predetermined inspection time is satisfied, the air conditioner performance examination module may determine that the air conditioner performance is normal. The notification display module may display a normal air conditioner performance notification to the user.

In some embodiments, when the first condition is not satisfied, the air conditioner performance examination module may determine that the air conditioner performance is abnormal. The notification display module may display an air conditioner inspection notification to the user.

In some embodiments, when a second condition for determining whether the evaporator core temperature value decreases by a predetermined fourth reference value or more from an initial value for a predetermined inspection time is satisfied, the air conditioner performance examination module may determine that the air conditioner performance is normal. The notification display module may display a normal air conditioner performance notification to the user. In some embodiments, when the second condition is not satisfied, the air conditioner performance examination module may determine that the air conditioner performance is abnormal. The notification display module may display an air conditioner inspection notification to the user.

In some embodiments, when any one of a first condition for determining whether the evaporator core temperature value reaches a predetermined third reference value for a predetermined inspection time and a second condition for determining whether the evaporator core temperature value decreases by a predetermined fourth reference value or more from an initial value for a predetermined inspection time is satisfied, the air conditioner performance examination module may determine that the air conditioner performance is normal. The notification display module may display a normal air conditioner performance notification to the user.

In some embodiments, when both the first and second conditions are not satisfied, the air conditioner performance examination module may determine that the air conditioner performance is abnormal. The notification display module may display an air conditioner inspection notification to the user.

In some embodiments, when it is determined that the evaporator core temperature sensor is abnormal, the air conditioner performance examination module may not examine the air conditioner performance. The notification display module may display an evaporator core temperature sensor inspection request notification to the user.

In some embodiments, the apparatus for examining an air conditioner for a vehicle may further include an air conditioner discharge parameter providing module configured to provide the air conditioner performance examination module with air conditioner discharge parameters for designating types of vents of the air conditioner and stage numbers of a blower.

In some embodiments, the air conditioner performance examination module may change conditions used to examine the air conditioner performance depending on the air conditioner discharge parameters.

A method of examining an air conditioner for a vehicle according to still another embodiment may include: receiving a vehicle outside air temperature value from an outside air temperature sensor; receiving a vehicle refrigerant pressure value from a refrigerant pressure sensor; examining the amount of refrigerant in a vehicle by using the outside air temperature value and the refrigerant pressure value; and displaying a notification to a user according to a result of examining the amount of refrigerant.

In some embodiments, the method may further include: receiving an evaporator core temperature value from an evaporator core temperature sensor of the vehicle; forcibly operating an air conditioner of the vehicle for a predetermined time; examining air conditioner performance of the vehicle by using the evaporator core temperature value according to the forced operation; and displaying a notification to the user according to a result of examining the air conditioner performance.

According to embodiments, the in-vehicle inspection code may be generated, or the notification may be displayed to the user depending on whether the refrigerant pressure is the reference value or less. The process of inspecting the vehicle may determine a lack of refrigerant on the basis of a change in temperature of the evaporator core temperature sensor by forcibly operating the air conditioner. Therefore, it is possible to detect a defect of the air conditioner of the vehicle at an early stage and improve the inspection reliability. In particular, it is possible to significantly improve the inspection performance in comparison with the method of inspecting the cooling performance of the vehicle in the related art. In the related art, the reliability is not high and it is impossible to distinguish between a case in which the abnormal refrigerant pressure is a reason and a case in which other factors are reasons in aa case when the inspection is performed on the basis of the temperature by examining the cooling performance by forcibly operating the air conditioner after identifying whether the minimum amount of refrigerant is injected through the inspection code.

### BRIEF DESCRIPTION OF THE DRAWINGS

FIG. 1 is a view of a system for examining an air conditioner for a vehicle according to an embodiment.

FIG. 2 is a block diagram of an apparatus for examining an air conditioner for a vehicle according to an embodiment.

FIG. 3 is a flowchart of a method of examining an air conditioner for a vehicle according to an embodiment.

FIG. 4 is a block diagram of an apparatus for examining an air conditioner for a vehicle according to an embodiment.

FIG. 5 is a block diagram of an apparatus for examining an air conditioner for a vehicle according to an embodiment.

FIG. 6 is a flowchart of a method of examining an air conditioner for a vehicle according to an embodiment.

FIG. 7 is a block diagram of an apparatus for examining an air conditioner for a vehicle according to an embodiment.

FIG. 8 is a view of air conditioner discharge parameters according to an embodiment.

FIG. 9 is a block diagram of a computing device according to an embodiment.

### DETAILED DESCRIPTION

Hereinafter, embodiments of the present disclosure are described in detail with reference to the accompanying drawings so that those with ordinary skill in the art to which the present disclosure pertains may carry out the embodiments and technical concepts of the disclosure. However, the embodiments of the present disclosure may be implemented in various different ways and are not limited to the embodiments described herein. Further, parts irrelevant to the description have been omitted in the drawings in order to clearly describe the present disclosure. Also, similar constituent elements are designated by similar reference numerals throughout the specification.

Throughout the specification and claims, unless explicitly described to the contrary, the words “comprise”, “have”, or “include” and variations, such as “comprises”, “comprising”, “has” or “having”, “includes” or “including”, should be understood to imply the inclusion of stated constituent elements, not the exclusion of any other constituent elements. The terms including ordinal numbers such as “first,” “second,” and the like may be used to describe various constituent elements, but the constituent elements are not limited by the terms. These terms are used only to distinguish one constituent element from another constituent element.

The terms “unit”, “part”, “module”, or the like, which are described in the specification, may mean a unit that may perform at least one function or operation described in the present specification, and the “unit”, “part”, or the like may be implemented by hardware, circuits, software, or a combination of hardware, circuits, and software. When a component, device, element, or the like of the present disclosure is described as having a purpose or performing an operation, function, or the like, the component, device, or element should be considered herein as being “configured to” meet that purpose or perform that operation or function.

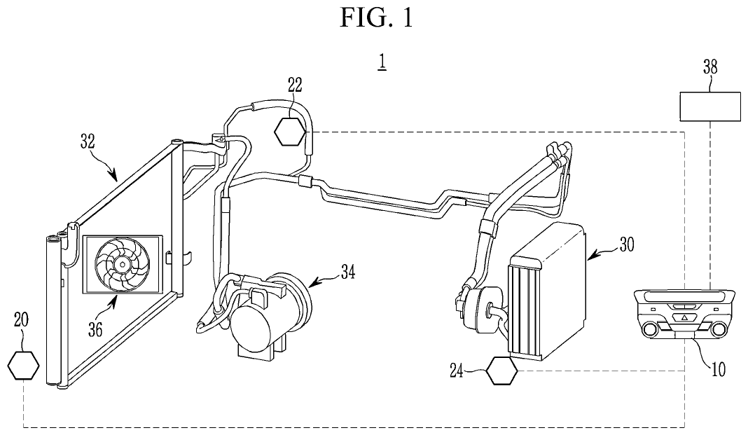

FIG. 1 is a view for explaining a system for examining an air conditioner for a vehicle according to an embodiment.

With reference to FIG. 1, a system 1 for examining an air conditioner for a vehicle according to an embodiment is described. The system 1 may include an apparatus 10 for examining an air conditioner for a vehicle, an outside air temperature sensor 20, a refrigerant pressure sensor 22, an evaporator core temperature sensor 24, an evaporator core 30, a condenser 32, a compressor 34, a blower 36, and/or other sensors 38.

The apparatus 10 for examining an air conditioner for a vehicle may include a fully automatic temperature controller (FATC). The FATC may automatically adjust a temperature in a vehicle. When a user sets a desired temperature, the FATC may automatically control a function of an air conditioner or a heater to maintain an internal temperature of the vehicle based on data received from various sensors. However, the apparatus 10 for examining an air conditioner for a vehicle may not be implemented only by the FATC. The apparatus 10 for examining an air conditioner for a vehicle may be implemented as another controller of the vehicle in accordance with implementation purposes and implementation environments.

The outside air temperature sensor 20 may measure an actual environment temperature outside the vehicle. The measured temperature information may be transferred to the apparatus 10 for examining an air conditioner for a vehicle including the FATC and is then used to set a temperature of the air conditioner or heater of the vehicle or manage temperatures of other components such as an engine. For example, the outside air temperature sensor may be mainly positioned on a front surface of the vehicle, such as a front bumper or a grille part of the vehicle, to accurately measure a temperature of an external environment.

The refrigerant pressure sensor 22 may be provided in an air conditioner system of the vehicle and may measure a pressure of a refrigerant. When the pressure of the refrigerant in the air conditioner system is excessively high or low, the air conditioner system cannot operate smoothly and may be broken down. In order to prevent the above-mentioned problems and maintain appropriate cooling performance, the refrigerant pressure sensor 22 may monitor the pressure of the refrigerant and transmit the monitoring result to the apparatus 10 for examining an air conditioner for a vehicle including the FATC. The apparatus 10 for examining an air conditioner for a vehicle may determine an operating state of the air conditioner system on the basis of the monitoring result.

The evaporator core temperature sensor 24 may measure a temperature in an evaporator (e.g., the evaporator core 30) in the air conditioner system of the vehicle and may transfer the measured information to the apparatus 10 for examining an air conditioner for a vehicle including the FATC. Therefore, when the apparatus 10 for examining an air conditioner for a vehicle determines that the temperature of the evaporator core 30 is excessively low, the apparatus 10 for examining an air conditioner for a vehicle may reduce or stop a flow of the refrigerant to prevent the evaporator from being frozen. Alternatively, when the apparatus 10 for examining an air conditioner for a vehicle determines that the temperature of the evaporator core 30 is excessively high, the apparatus 10 for examining an air conditioner for a vehicle provides a larger amount of refrigerant to the evaporator so that the air conditioner system may produce a larger amount of cold air.

The condenser 32 is provided at a front side of the vehicle and may be positioned immediately rearward of a radiator. The condenser 32 may radiate heat by cooling the refrigerant compressed in the air conditioner system of the vehicle. The compressor 34 may apply energy by compressing the refrigerant and enable the refrigerant to move through a refrigerant circulation system. The blower 36 may supply air into the vehicle and may send air that is cooled in the evaporator of the air conditioner system into the vehicle.

The other sensors 38 are sensors excluding the above-mentioned sensors. The other sensors 38 may collect various types of information about the vehicle and transfer the information to the apparatus 10 for examining an air conditioner for a vehicle.

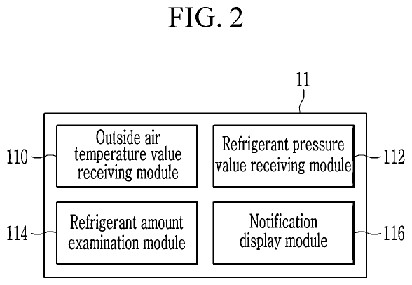

FIG. 2 is a block diagram for explaining an apparatus for examining an air conditioner for a vehicle according to an embodiment.

With reference to FIG. 2, an apparatus 11 for examining an air conditioner for a vehicle according to an embodiment may be an element corresponding to the apparatus 10 for examining an air conditioner for a vehicle in FIG. 1. The apparatus 11 for examining an air conditioner for a vehicle may receive a vehicle outside air temperature value from the outside air temperature sensor 20 and may receive a refrigerant pressure value from the refrigerant pressure sensor 22. The apparatus 11 for examining an air conditioner for a vehicle may display an inspection code when the corresponding values satisfy predetermined criteria.

Specifically, the apparatus 11 for examining an air conditioner for a vehicle may include an outside air temperature value receiving module 110, a refrigerant pressure value receiving module 112, a refrigerant amount examination module 114, and a notification display module 116.

The outside air temperature value receiving module 110 may receive a vehicle outside air temperature value from the outside air temperature sensor 20. In other words, the outside air temperature value receiving module 110 may measure a temperature of an actual environment outside the vehicle and may transfer the information on the temperature to the refrigerant amount examination module 114. Meanwhile, the refrigerant pressure value receiving module 112 may receive a vehicle refrigerant pressure value from the refrigerant pressure sensor 22 and transmit the vehicle refrigerant pressure value to the refrigerant amount examination module 114.

The refrigerant amount examination module 114 may examine the minimum amount of refrigerant in the vehicle by using the outside air temperature value, which is received from the outside air temperature sensor 20 by the outside air temperature value receiving module 110, and the refrigerant pressure value, which is received from the refrigerant pressure sensor 22 by the refrigerant pressure value receiving module 112. It is difficult to consistently examine an accurate amount of refrigerant in the vehicle because of various external variables. Therefore, the refrigerant amount examination module 114 may examine whether the amount of refrigerant in the vehicle is a predetermined minimum amount or more.

The notification display module 116 may display, to the user, a notification related to a result of examining the minimum amount of refrigerant by the refrigerant amount examination module 114. For example, the notification display module 116 may display the result of examining the minimum amount of refrigerant as an inspection code. Of course, the method of displaying the notification to the user is not limited to the method of displaying the inspection code, and various methods may be used.

In a case when the outside air temperature value is small, the refrigerant pressure is sometimes low, even though the amount of refrigerant is large. In this case, because the amount of refrigerant is sufficiently present, the refrigerant amount examination module 114 may examine the minimum amount of refrigerant only when the outside air temperature value is at a predetermined level or higher. Specifically, the refrigerant amount examination module 114 may examine the minimum amount of refrigerant by using the refrigerant pressure value received from the refrigerant pressure sensor 22 only when the outside air temperature value is equal to or more than a predetermined first reference value. When the outside air temperature value is less than the first reference value, the refrigerant amount examination module 114 may not examine the minimum amount of refrigerant. In some embodiments, the first reference value may be set to 10 to 13° C. Particularly, the first reference value may be set to 10° C. As described above, it is possible to prevent the refrigerant amount examination module 114 from examining the amount of refrigerant in a situation in which the refrigerant pressure is not accurately measured, which degrades examination accuracy. Alternatively, it is possible to prevent a notification, which unnecessarily requests the user to perform inspection even when the amount of refrigerant is sufficient, from being displayed to the user. In some embodiments, when the outside air temperature value is less than the first reference value, the notification display module 116 may display, to the user, a notification that indicates a situation in which the minimum amount of refrigerant cannot be examined.

During the process of examining the amount of refrigerant, the refrigerant amount examination module 114 may inspect the refrigerant pressure multiple times. When the inspection result, which indicates that the amount of refrigerant is at a predetermined level or less, continuously occurs, the refrigerant amount examination module 114 may determine that the amount of refrigerant is abnormal. Specifically, in a case when the refrigerant pressure received from the refrigerant pressure sensor 22 is continuously maintained to be a predetermined second reference value or less for a predetermined time, the refrigerant amount examination module 114 may determine that the amount of refrigerant is abnormal. Alternatively, when the refrigerant pressure is not continuously maintained to be the second reference value or less for a predetermined time, the refrigerant amount examination module 114 may determine that the amount of refrigerant is normal. In some embodiments, when the refrigerant pressure is continuously 32 psi or lower for 10 seconds, the refrigerant amount examination module 114 may determine that the amount of refrigerant is abnormal. In this case, when the amount of refrigerant is normal or the amount of refrigerant is not abnormal may mean that the amount of refrigerant is equal to or larger than the minimum amount. When the amount of refrigerant is abnormal, it may mean that the amount of refrigerant is smaller than the minimum amount.

In some embodiments, in a case when the refrigerant pressure received from the refrigerant pressure sensor 22 is continuously maintained to be the predetermined second reference value or less for the predetermined time, the notification display module 116 may display, to the user, a refrigerant amount inspection request notification. The notification may request the user to inspect the amount of refrigerant because the inspection result indicates that the amount of refrigerant is abnormal. Alternatively, in some embodiments, in case that the refrigerant pressure is not continuously maintained to be the second reference value or less for the predetermined time, the notification display module 116 may display, to the user, a normal refrigerant amount notification. The notification may indicate that the amount of refrigerant is not abnormal, i.e., normal according to the inspection result.

In a case when it is determined that the outside air temperature sensor or the refrigerant pressure sensor is abnormal, the refrigerant amount examination module 114 may not perform the examination of the amount of refrigerant. Whether the outside air temperature sensor or the refrigerant pressure sensor is abnormal may be determined by various methods already publicly known, and the scope of the present disclosure is not limited to any particular method. In a case when it is determined that the outside air temperature sensor or the refrigerant pressure sensor is abnormal, the notification display module 116 may display, to the user, an outside air temperature sensor inspection request notification. The notification may request the user to inspect the outside air temperature sensor, or a refrigerant pressure sensor inspection request notification that requests the user to inspect the refrigerant pressure sensor.

According to the present embodiment, because the in-vehicle inspection code is generated or the notification is displayed to the user depending on whether the refrigerant pressure is the reference value or less, it is possible to detect a defect of the air conditioner of the vehicle at an early stage and improve the inspection reliability.

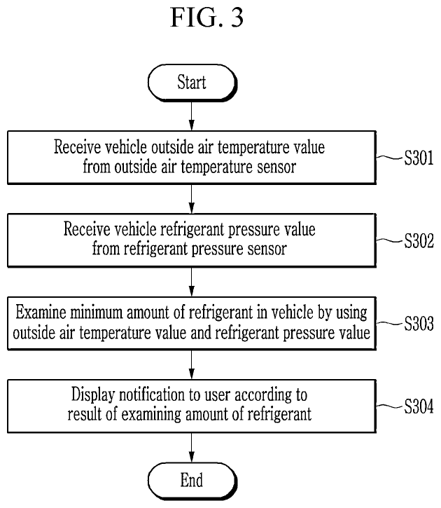

FIG. 3 is a flowchart for explaining a method of examining an air conditioner for a vehicle according to an embodiment.

With reference to FIG. 3, a method of examining an air conditioner for a vehicle according to an embodiment may include receiving the vehicle outside air temperature value from the outside air temperature sensor (operation S301). The method may also include receiving the vehicle refrigerant pressure value from the refrigerant pressure sensor (operation S302) and examining the minimum amount of refrigerant in the vehicle by using the outside air temperature value and the refrigerant pressure value (operation S303). The method may further include displaying the notification to the user depending on the result of examining the amount of refrigerant (operation S304).

Because the more specific details of the method of examining an air conditioner for a vehicle may be described or applied with reference to the description of the embodiments disclosed in the present specification, a repeated description has been omitted.

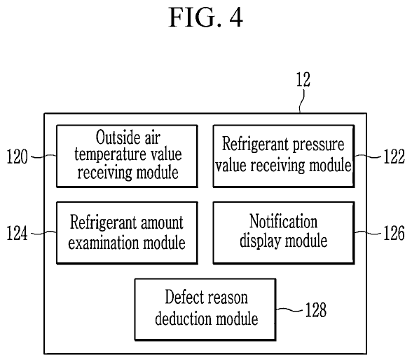

FIG. 4 is a block diagram for explaining an apparatus for examining an air conditioner for a vehicle according to an embodiment.

With reference to FIG. 4, an apparatus 12 for examining an air conditioner for a vehicle according to an embodiment may be an element corresponding to the apparatus 10 for examining an air conditioner for a vehicle in FIG. 1. The apparatus 12 for examining an air conditioner for a vehicle may receive a vehicle outside air temperature value from the outside air temperature sensor 20 and may receive a refrigerant pressure value from the refrigerant pressure sensor 22. The apparatus 12 for examining an air conditioner for a vehicle may display an inspection code when the corresponding values satisfy predetermined criteria. The apparatus 12 for examining an air conditioner for a vehicle may deduce a defect reason in a case when it is determined that the amount of refrigerant is abnormal, i.e., the amount of refrigerant is smaller than the minimum amount of refrigerant.

Specifically, the apparatus 12 for examining an air conditioner for a vehicle may include an outside air temperature value receiving module 120, a refrigerant pressure value receiving module 122, a refrigerant amount examination module 124, a notification display module 126, and a defect reason deduction module 128. The outside air temperature value receiving module 120, the refrigerant pressure value receiving module 122, the refrigerant amount examination module 124, and the notification display module 126 may be described by referring to or applying the description of the outside air temperature value receiving module 110, the refrigerant pressure value receiving module 112, the refrigerant amount examination module 114, and the notification display module 116, which are described above with reference to FIG. 2, in terms of the contents that do not contradict the contents described in the present embodiment. Therefore, the description here is focused on the differences.

In some embodiments, the refrigerant amount examination module 124 may examine the minimum amount of refrigerant while the vehicle travels. That is to say, the refrigerant amount examination module 124 may examine the minimum amount of refrigerant in the vehicle while the vehicle travels by using the outside air temperature value, which is received from the outside air temperature sensor 20 by the outside air temperature value receiving module 120 while the vehicle travels, and by using the refrigerant pressure value, which is received from the refrigerant pressure sensor 22 by the refrigerant pressure value receiving module 122 while the vehicle travels. The examination of the amount of refrigerant may be performed in accordance with the contents described above with reference to FIG. 2. The notification display module 126 may display, to the user, a notification related to the result of examining the minimum amount of refrigerant while the vehicle travels. In particular, in case that the amount of refrigerant is abnormal, the notification display module 126 may display a refrigerant amount inspection request notification, which requests an inspection, on a cluster of the vehicle while the vehicle travels. Alternatively, in case that it is determined that the outside air temperature sensor or the refrigerant pressure sensor is abnormal, the notification display module 116 may display an outside air temperature sensor inspection request notification, which requests the user to inspect the outside air temperature sensor, or a refrigerant pressure sensor inspection request notification, which requests the user to inspect the refrigerant pressure sensor, on the cluster of the vehicle while the vehicle travels.

Meanwhile, in a case when it is determined that the amount of refrigerant is abnormal, the defect reason deduction module 128 may deduce a defect reason on the basis of refrigerant injection history data in a factory. In a case when the refrigerant is injected into the vehicle in the factory, history data may be stored in a database and managed. The history data may include the injection amount, a state of the vehicle during the injection process, the order of working processes, and/or an environment such as temperature or humidity during the working process, which are set when the refrigerant is injected. The defect reason deduction module 128 may simply display the inspection result in the form of the inspection code or the notification. However, module 128 may also enable the user to easily recognize a defect reason by providing the user with the injection amount during the process of injecting the refrigerant, the state of the vehicle during the injection process, the order of the working processes, and the environment such as temperature or humidity during the working process, or by providing the user with history data deviating from the normal range.

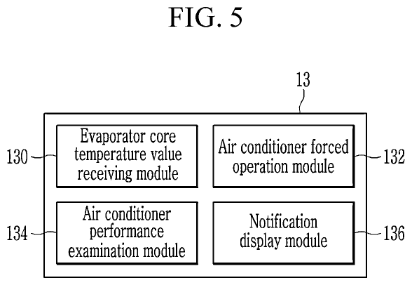

FIG. 5 is a block diagram for explaining an apparatus for examining an air conditioner for a vehicle according to an embodiment.

With reference to FIG. 5, an apparatus 13 for examining an air conditioner for a vehicle according to an embodiment may be an element corresponding to the apparatus 10 for examining an air conditioner for a vehicle in FIG. 1. The apparatus 13 for examining an air conditioner for a vehicle may inspect air conditioner performance while operating the air conditioner by forcibly operating the compressor 34 and the blower 36.

Specifically, the apparatus 13 for examining an air conditioner for a vehicle may include an evaporator core temperature value receiving module 130, an air conditioner forced operation module 132, an air conditioner performance examination module 134, and a notification display module 136.

The evaporator core temperature value receiving module 130 may receive an evaporator core temperature value from the evaporator core temperature sensor 24 of the vehicle. The evaporator core temperature value receiving module 130 may continuously receive the evaporator core temperature value after an engine of the vehicle operates.

The air conditioner forced operation module 132 may forcibly operate the air conditioner of the vehicle for a predetermined time. Flow rate setting, inside air or outside air setting, flow direction setting, and the like may be variously combined during the forced operation.

The air conditioner performance examination module 134 may examine the air conditioner performance of the vehicle by using the evaporator core temperature value according to the forced operation. In other words, the air conditioner performance examination module 134 may examine the air conditioner performance of the vehicle by detecting a change in evaporator core temperature value when the forced operation is performed under the situation of flow rate setting, inside air or outside air setting, and flow direction setting determined by the air conditioner forced operation module 132.

The notification display module 136 may display a notification to the user in accordance with the result of examining the air conditioner performance. For example, the notification display module 136 may display the result of examining the air conditioner performance as an inspection code. Of course, the method of displaying the notification to the user is not limited to the method of displaying the inspection code, and various methods may be used.

In some embodiments, the air conditioner performance examination module 134 may determine that the air conditioner performance is normal in a case when a first condition for determining whether the evaporator core temperature value reaches a predetermined third reference value for a predetermined inspection time is satisfied. For example, the air conditioner performance examination module 134 may determine that the air conditioner performance is normal when a condition for determining whether the evaporator core temperature value reaches 8° C. for 40 seconds after the forced operation starts is satisfied. In this case, the notification display module 136 may display, to the user, a normal air conditioner performance notification indicating that the air conditioner performance is normal. Alternatively, in case that the first condition is not satisfied, the air conditioner performance examination module 134 may determine that the air conditioner performance is abnormal. For example, the air conditioner performance examination module 134 may determine that the air conditioner performance is abnormal in a case when the condition for determining whether the evaporator core temperature value reaches 8° C. for 40 seconds after the forced operation starts is not satisfied. In this case, the notification display module 136 may display, to the user, an air conditioner inspection notification, which requests an inspection, when it is determined that the air conditioner performance is abnormal.

In some embodiments, the air conditioner performance examination module 134 may determine that the air conditioner performance is normal in case that a second condition for determining whether the evaporator core temperature value decreases by a predetermined fourth reference value or more from an initial value for a predetermined inspection time is satisfied. For example, the air conditioner performance examination module 134 may determine that the air conditioner performance is normal in a case when a condition for determining whether the evaporator core temperature value decreases by 10° C. or more from the initial value for 40 seconds after the forced operation starts is satisfied. In this case, the notification display module 136 may display, to the user, the normal air conditioner performance notification indicating that the air conditioner performance is normal. Alternatively, in case that the second condition is not satisfied, the air conditioner performance examination module 134 may determine that the air conditioner performance is abnormal. For example, the air conditioner performance examination module 134 may determine that the air conditioner performance is abnormal when the condition for determining whether the evaporator core temperature value decreases by 10° C. or more from the initial value for 40 seconds after the forced operation starts is not satisfied. In this case, the notification display module 136 may display, to the user, the air conditioner inspection notification, which requests the inspection, when it is determined that the air conditioner performance is abnormal.

In some embodiments, the air conditioner performance examination module 134 may determine that the air conditioner performance is normal in a case when any one of the first conditions for determining whether the evaporator core temperature value reaches the predetermined third reference value for the predetermined inspection time and the second condition for determining whether the evaporator core temperature value decreases by the predetermined fourth reference value or more from the initial value for the predetermined inspection time is satisfied. In this case, the notification display module 136 may display, to the user, the normal air conditioner performance notification indicating that the air conditioner performance is normal. Alternatively, in case that both the first and second conditions are not satisfied, the air conditioner performance examination module 134 may determine that the air conditioner performance is abnormal. In this case, the notification display module 136 may display, to the user, the air conditioner inspection notification, which requests the inspection, when it is determined that the air conditioner performance is abnormal.

In some embodiments, the air conditioner performance examination module 134 may determine that the air conditioner performance is normal in a case when both the first condition for determining whether the evaporator core temperature value reaches the predetermined third reference value for the predetermined inspection time and the second condition for determining whether the evaporator core temperature value decreases by the predetermined fourth reference value or more from the initial value for the predetermined inspection time are satisfied. In this case, the notification display module 136 may display, to the user, the normal air conditioner performance notification indicating that the air conditioner performance is normal. Alternatively, in case that even any one of the first or second conditions is not satisfied, the air conditioner performance examination module 134 may determine that the air conditioner performance is abnormal. In this case, the notification display module 136 may display, to the user, the air conditioner inspection notification, which requests the inspection, when it is determined that the air conditioner performance is abnormal.

In some embodiments, the air conditioner performance examination module 134 may use only the first condition to determine whether the air conditioner performance of a first type of vehicle is normal. The module 134 may use only the second condition to determine whether the air conditioner performance of a second type of vehicle is normal. The module 134 may use a logical sum of the first and second conditions to determine whether the air conditioner performance of a third type of vehicle is normal. The module 134 may use a logical product of the first and second conditions to determine whether the air conditioner performance of a fourth type of vehicle is normal. The air conditioner performance examination module 134 may make and store data on relationships between the types of vehicles and the air conditioner performance determination methods and automatically apply the air conditioner performance determination methods differently depending on the types of vehicles without the need for the user to designate the air conditioner performance determination methods one by one depending on the types of vehicles.

The refrigerant amount examination module 134 may not perform the examination of the air conditioner performance in a case when it is determined that the evaporator core temperature sensor is abnormal. Whether the evaporator core temperature sensor is abnormal may be determined by various methods already publicly known, and the scope of the present disclosure is not limited to any particular method. In a case when it is determined that the evaporator core temperature sensor is abnormal, the notification display module 136 may display, to the user, an evaporator core temperature sensor inspection request notification that requests the user to inspect the evaporator core temperature sensor.

According to the present embodiment, because the process of inspecting the vehicle may determine a lack of refrigerant on the basis of a change in temperature of the evaporator core temperature sensor by forcibly operating the air conditioner, it is possible to detect a defect of the air conditioner of the vehicle at an early stage and improve the inspection reliability.

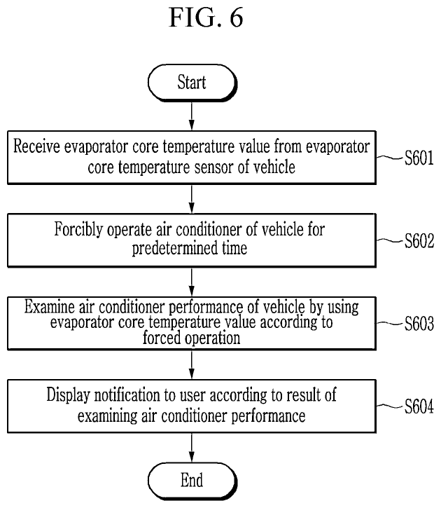

FIG. 6 is a flowchart for explaining a method of examining an air conditioner for a vehicle according to an embodiment.

With reference to FIG. 6, the method of examining an air conditioner for a vehicle according to an embodiment may include receiving the evaporator core temperature value from the evaporator core temperature sensor of the vehicle (operation S601). The method may also include forcibly operating the air conditioner of the vehicle for the predetermined time (operation S602) and examining the air conditioner performance of the vehicle by using the evaporator core temperature value according to the forced operation (operation S603). The method may also include displaying the notification to the user according to the result of examining the air conditioner performance (operation S604). Because the more specific details of the method of examining an air conditioner for a vehicle may be described or applied with reference to the description of the embodiments disclosed in the present specification, a repeated description has been omitted.

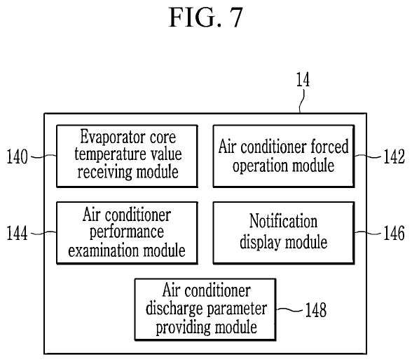

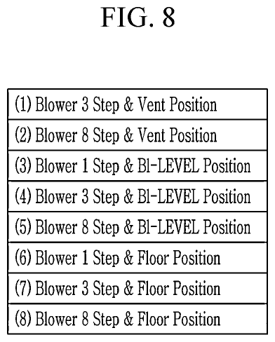

FIG. 7 is a block diagram for explaining an apparatus for examining an air conditioner for a vehicle according to an embodiment. FIG. 8 is a view for explaining an air conditioner discharge parameter according to an embodiment.

With reference to FIG. 7, an apparatus 14 for examining an air conditioner for a vehicle according to an embodiment may be an element corresponding to the apparatus 10 for examining an air conditioner for a vehicle in FIG. 1. The apparatus 14 for examining an air conditioner for a vehicle may inspect air conditioner performance while operating the air conditioner by forcibly operating the compressor 34 and the blower 36 so that the performance examination is performed under various air conditioner discharge environments.

Specifically, the apparatus 14 for examining an air conditioner for a vehicle may include an evaporator core temperature value receiving module 140, an air conditioner forced operation module 142, an air conditioner performance examination module 144, a notification display module 146, and an air conditioner discharge parameter providing module 148. The evaporator core temperature value receiving module 140, the air conditioner forced operation module 142, the air conditioner performance examination module 144, and the notification display module 146 may be described by referring to or applying the description of the evaporator core temperature value receiving module 130, the air conditioner forced operation module 132, the air conditioner performance examination module 134, and the notification display module 136, which are described above with reference to FIG. 6, in terms of the contents that do not contradict the contents described in the present embodiment. Therefore, the description is focused on the differences.

The air conditioner discharge parameter providing module 148 may provide the air conditioner performance examination module 144 with air conditioner discharge parameters for designating types of vents of the air conditioner and stage numbers of the blower. Further, the air conditioner performance examination module 144 may change conditions used to examine the air conditioner performance on the basis of the air conditioner discharge parameters provided from the air conditioner discharge parameter providing module 148.

With reference to FIG. 8, the air conditioner discharge parameter providing module 148 may provide the air conditioner performance examination module 144 with a first condition in which the blower stage number is set to 3 and the vent type is set to “Vent Position”. The module 148 may provide the module 144 with a second condition in which the blower stage number is set to 8 and the vent type is set to “Vent Position”. The module 148 may provide the module 144 with a third condition in which the blower stage number is set to 1 and the vent type is set to “BI-LEVEL Position”. The module 148 may provide the module 144 with a fourth condition in which the blower stage number is set to 3 and the vent type is set to “BI-LEVEL Position”. The module 148 may further provide the module 144 with a fifth condition in which the blower stage number is set to 8 and the vent type is set to “BI-LEVEL Position”, a sixth condition in which the blower stage number is set to 1 and the vent type is set to “Floor Position”, a seventh condition in which the blower stage number is set to 3 and the vent type is set to “Floor Position”, and an eighth condition in which the blower stage number is set to 8 and the vent type is set to “Floor Position”. The air conditioner performance examination module 144 may select at least one of the first to eighth conditions depending on the types of vehicles and the examination environments and may examine the air conditioner performance according to the forced operation corresponding to the selected condition.

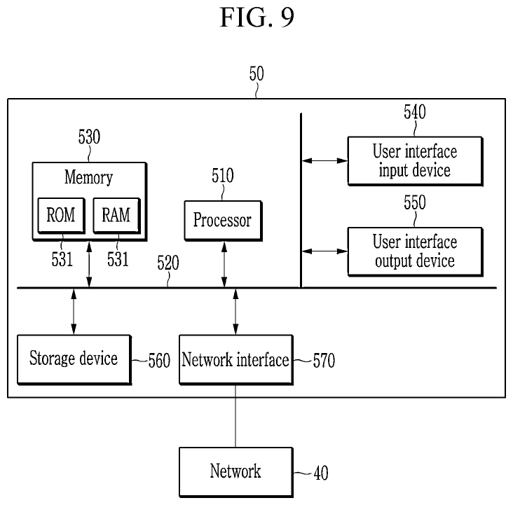

FIG. 9 is a view for explaining a computing device according to an embodiment.

With reference to FIG. 9, the apparatus and method for examining an air conditioner for a vehicle according to the embodiments may be implemented by using a computing device 50.

The computing device 50 may include at least one of a processor 510, a memory 530, a user interface input device 540, a user interface output device 550, and a storage device 560 that communicate with one another via a bus 520. The computing device 50 may also include a network interface 570 electrically connected to a network 40. The network interface 570 may transmit or receive a signal to or from another object through the network 40.

The processor 510 may be implemented by various types such as a micro-controller unit (MCU), an application processor (AP), a central processing unit (CPU), a graphic processing unit (GPU), a neural processing unit (NPU), a quantum processing unit (QPU), and the like. The processor 510 may be any semiconductor device that executes instructions stored in the memory 530 or the storage device 560. The processor 510 may be configured to implement the functions and methods described above with reference to FIGS. 1-8.

The memory 530 and the storage device 560 may include various types of volatile or nonvolatile storage media. Examples of the memory may include a read-only memory (ROM) 531 and a random-access memory (RAM) 532. In the present embodiment, the memory 530 may be positioned inside or outside the processor 510. The memory 530 may be connected to the processor 510 through various already known means.

In some embodiments, the configuration or function of at least a part of the apparatus and method for examining an air conditioner for a vehicle according to the embodiments may be implemented as a program or software executed by the computing device 50. The program or software may be stored in a computer-readable medium. Specifically, the computer-readable medium according to the embodiment may be a medium made by recording a program, which is stored in the memory 530 or the storage device 560, or a program, which is configured to execute the steps included in the apparatus and method for examining an air conditioner for a vehicle according to the embodiments, in a computer including the processor 510 for executing the instruction.

In some embodiments, a configuration or function of at least a part of the apparatus and method for examining an air conditioner for a vehicle according to the embodiments may be implemented by using the hardware or circuit of the computing device 50 or implemented as separate hardware or circuit that may be electrically connected to the computing device 50.

According to the embodiments described above, the in-vehicle inspection code may be generated or the notification may be displayed to the user, depending on whether the refrigerant pressure is less than or equal to the reference value. The process of inspecting the vehicle may determine a lack of refrigerant on the basis of a change in temperature of the evaporator core temperature sensor by forcibly operating the air conditioner. Therefore, it is possible to detect a defect of the air conditioner of the vehicle at an early stage and improve the inspection reliability. In particular, it is possible to significantly improve the inspection performance in comparison with the method of inspecting the cooling performance of the vehicle in the related art. In the related art, the reliability is not high and it is impossible to distinguish between a case in which the abnormal refrigerant pressure is a reason and a case in which other factors are reasons when the inspection is performed on the basis of the temperature by examining the cooling performance by forcibly operating the air conditioner after identifying whether the minimum amount of refrigerant is injected through the inspection code.

Although the embodiments of the present disclosure have been described in detail above, the scope of the present disclosure is not limited thereto. It should be construed that many variations and modifications made by those having ordinary skill in the art using the basic concepts of the present disclosure, which are defined in the following claims, will also fall within the scope of the present disclosure.

What is claimed is:

1. An apparatus for examining an air conditioner for a vehicle, the apparatus comprising:
an outside air temperature value receiving module configured to receive a vehicle outside air temperature value from an outside air temperature sensor;
a refrigerant pressure value receiving module configured to receive a vehicle refrigerant pressure value from a refrigerant pressure sensor;
a refrigerant amount examination module configured to examine a minimum amount of refrigerant in a vehicle by using the outside air temperature value and the refrigerant pressure value; and
a notification display module configured to display a notification to a user according to a result of examining the minimum amount of refrigerant.

2. The apparatus of claim 1, wherein:
the refrigerant amount examination module examines the minimum amount of refrigerant by using the refrigerant pressure value when the outside air temperature value is equal to or more than a predetermined first reference value.

3. The apparatus of claim 2, wherein:
when the outside air temperature value is less than the predetermined first reference value, the refrigerant amount examination module does not examine the minimum amount of refrigerant; and
the notification display module displays, to the user, a notification indicating that the minimum amount of refrigerant cannot be examined.

4. The apparatus of claim 3, wherein:
when the refrigerant pressure is continuously maintained to be less than or equal to a predetermined second reference value for a predetermined time, the refrigerant amount examination module determines that the minimum amount of refrigerant is abnormal; and
the notification display module displays a refrigerant amount inspection request notification to the user.

5. The apparatus of claim 4, wherein:
when the refrigerant pressure is not continuously maintained to be less than or equal to the second reference value for the predetermined time, the refrigerant amount examination module determines that the minimum amount of refrigerant is normal; and
the notification display module displays a normal refrigerant amount notification to the user.

6. The apparatus of claim 1, wherein:
when it is determined that the outside air temperature sensor or the refrigerant pressure sensor is abnormal, the refrigerant amount examination module does not examine the minimum amount of refrigerant; and
the notification display module displays an outside air temperature sensor inspection request notification or a refrigerant pressure sensor inspection request notification to the user.

7. The apparatus of claim 1, wherein:
the refrigerant amount examination module examines the minimum amount of refrigerant while the vehicle travels; and
the notification display module displays the notification while the vehicle travels.

8. The apparatus of claim 1, further comprising:
a defect reason deduction module configured to deduce a defect reason on the basis of refrigerant injection history data in a factory when it is determined that the amount of refrigerant is abnormal.

9. An apparatus for examining an air conditioner for a vehicle, the apparatus comprising:
an evaporator core temperature value receiving module configured to receive an evaporator core temperature value from an evaporator core temperature sensor of a vehicle;
an air conditioner forced operation module configured to forcibly operate an air conditioner of the vehicle for a predetermined time;
an air conditioner performance examination module configured to examine air conditioner performance of the vehicle by using the evaporator core temperature value according to the forced operation; and
a notification display module configured to display a notification to a user according to a result of examining the air conditioner performance.

10. The apparatus of claim 9, wherein:
when a first condition for determining whether the evaporator core temperature value reaches a predetermined third reference value for a predetermined inspection time is satisfied, the air conditioner performance examination module determines that the air conditioner performance is normal; and
the notification display module displays a normal air conditioner performance notification to the user.

11. The apparatus of claim 10, wherein:
when the first condition is not satisfied, the air conditioner performance examination module determines that the air conditioner performance is abnormal; and
the notification display module displays an air conditioner inspection notification to the user.

12. The apparatus of claim 9, wherein:
when a second condition for determining whether the evaporator core temperature value decreases by a predetermined fourth reference value or more from an initial value for a predetermined inspection time is satisfied, the air conditioner performance examination module determines that the air conditioner performance is normal; and
the notification display module displays a normal air conditioner performance notification to the user.

13. The apparatus of claim 12, wherein:
when the second condition is not satisfied, the air conditioner performance examination module determines that the air conditioner performance is abnormal; and
the notification display module displays an air conditioner inspection notification to the user.

14. The apparatus of claim 9, wherein:
when any one of a first condition for determining whether the evaporator core temperature value reaches a predetermined third reference value for a predetermined inspection time or a second condition for determining whether the evaporator core temperature value decreases by a predetermined fourth reference value or more from an initial value for a predetermined inspection time is satisfied, the air conditioner performance examination module determines that the air conditioner performance is normal; and
the notification display module displays a normal air conditioner performance notification to the user.

15. The apparatus of claim 14, wherein:
when both the first and second conditions are not satisfied, the air conditioner performance examination module determines that the air conditioner performance is abnormal; and
the notification display module displays an air conditioner inspection notification to the user.

16. The apparatus of claim 9, wherein:
when it is determined that the evaporator core temperature sensor is abnormal, the air conditioner performance examination module does not examine the air conditioner performance; and
the notification display module displays an evaporator core temperature sensor inspection request notification to the user.

17. The apparatus of claim 9, further comprising:
an air conditioner discharge parameter providing module configured to provide the air conditioner performance examination module with air conditioner discharge parameters for designating types of vents of the air conditioner and stage numbers of a blower.

18. The apparatus of claim 17, wherein:
the air conditioner performance examination module changes conditions used to examine the air conditioner performance depending on the air conditioner discharge parameters.

19. A method of examining an air conditioner for a vehicle, the method comprising:
receiving a vehicle outside air temperature value from an outside air temperature sensor;
receiving a vehicle refrigerant pressure value from a refrigerant pressure sensor;
examining a minimum amount of refrigerant in a vehicle by using the outside air temperature value and the refrigerant pressure value; and
displaying a notification to a user according to a result of examining the amount of refrigerant.

20. The method of claim 19, further comprising:
receiving an evaporator core temperature value from an evaporator core temperature sensor of the vehicle;
forcibly operating an air conditioner of the vehicle for a predetermined time;
examining air conditioner performance of the vehicle by using the evaporator core temperature value according to the forced operation; and
displaying a notification to the user according to a result of examining the air conditioner performance.
